(19) United States
(12) Patent Application Publication
(10) Pub. No.: US 2023/0177527 A1
(43) Pub. Date: Jun. 8, 2023

(54) BLOCK CHAIN SYSTEM, AND BIOLOGICAL PRODUCT MONITORING METHOD AND DEVICE

(71) Applicant: AGRICULTURAL GENOMICS INSTITUTE AT SHENZHEN, CHINESE ACADEMY OF AGRICULTURAL SCIENCES, Shenzhen (CN)

(72) Inventors: Jianbin YAN, Shenzhen (CN); Sanwen HUANG, Shenzhen (CN)

(21) Appl. No.: 18/153,773

(22) Filed: Jan. 12, 2023

Related U.S. Application Data
(63) Continuation of application No. PCT/CN2021/093476, filed on May 13, 2021.

(30) Foreign Application Priority Data
Jul. 16, 2020 (CN) 202010687047.5

(51) Int. Cl. G06Q 30/018

(52) U.S. Cl. CPC G06Q 30/0185

(57) ABSTRACT

Disclosed is a block chain system (100), including a product inspection layer (110) which stores a preset inspection standard, for determining first inspection data of a biological product and performing an analysis on the first inspection data to generate second inspection data of the biological product, wherein the preset inspection standard is an inspection standard based on a biological metabonomics method. By presetting the inspection standards based on the biological metabonomics method in the product inspection layer, the block chain system (100) achieves the purpose of combining the block chain system with the biological metabonomics method. Moreover, the system (100) not only has the ability of detecting product quality of the biological product, but also can effectively improve a data utilization rate and enrich dimensions of data mining. Thus, the competitive fairness degree between inspection mechanisms can be effectively improved.

### CROSS-REFERENCE TO RELATED APPLICATIONS

This application is a continuation of International Application No. PCT/CN2021/093476, filed on May 13, 2021, which claims priority to Chinese Patent Application No. 202010687047.5, filed on Jul. 16, 2020. The disclosures of the aforementioned applications are hereby incorporated by reference in their entireties.

### TECHNICAL FIELD

The disclosure relates to the field of block chain technology, in particular to a block chain system, a biological product monitoring method and device, a non-transitory computer-readable storage medium and an electronic device.

### BACKGROUND

As we all know, the security of biological products is an important branch of livelihood security, and also a difficult point in management of national livelihood. The importance of the security of biological products is self-evident. Block chain technology resolves a problem of isolated islands of monitoring data and establishes a trust mechanism between users relying on technical characteristics such as tamper resistance, distributed storage and smart contracts.

However, existing monitoring solutions based on the block chain technology are mainly weighted in monitoring of surface information of products, environmental parameters and circulation process. Although a specific link of a problem may be traced back when it happens, the biological product itself cannot be monitored, and there are many fraud loopholes, resulting in that the security of biological products may not be well guaranteed.

### SUMMARY

The present disclosure is proposed in order to solve the technical problems described above. Embodiments of the present disclosure provide a block chain system, a biological product monitoring method and device, a non-transitory computer-readable storage medium and an electronic device.

According to a first aspect, an embodiment of the present disclosure provides a block chain system. The block chain system includes a product inspection layer where a preset inspection standard is stored, used for determining first inspection data of a biological product, and performing an analysis of the first inspection data to generate second inspection data of the biological product, where the preset inspection standard is an inspection standard based on a biological metabonomics method.

In an embodiment of the present disclosure, the determining first inspection data of a biological product includes: acquiring inspection reward information corresponding to the biological product sent by a first user; generating and publishing contract information according to the inspection reward information; determining m second users according to the contract information; and acquiring m groups of inspection data of the biological product offered by the m second users as the first inspection data of the biological product.

In an embodiment of the present disclosure, after the determining m second users according to the contract information, the determining first inspection data of a biological product further includes: if n second users among the m second users break a contract, re-determining n new second users, where the n new second users and (m-n) second users without breach of the contract constitute new m second users. Therein, the acquiring m groups of inspection data of the biological product offered by the m second users as the first inspection data of the biological product includes: acquiring m groups of inspection data of the biological product offered by the new m second users as the first inspection data of the biological product.

In an embodiment of the present disclosure, the performing an analysis of the first inspection data to generate second inspection data of the biological product includes: determining a median of the m groups of inspection data according to the m groups of inspection data; and generating the second inspection data according to the median and the m groups of inspection data, where the second inspection data comprises inspection analysis data and product inspection result data of the m groups of inspection data.

In an embodiment of the present disclosure, the block chain system further includes a data application layer in communication with the product inspection layer, used for acquiring a product inspection code generated based on the second inspection data, a product circulation code generated based on product circulation information of the biological product, and a product registration code generated based on product registration information of the biological product, and generating a transaction contract according to the product inspection code, the product circulation code and the product registration code.

In an embodiment of the present disclosure, the block chain system further includes a product circulation layer in communication with the data application layer, used for storing the product circulation information, generating the product circulation code according to the product circulation information, and transmitting the product circulation code to the data application layer.

In an embodiment of the present disclosure, the block chain system further includes a product registration layer in communication with the data application layer, used for storing the product registration information, generating the product registration code according to the product registration information, and transmitting the product registration code to the data application layer.

In an embodiment of the present disclosure, the biological product includes at least one of agricultural products, reprocessed agricultural products, traditional Chinese medicine products, reprocessed traditional Chinese medicine products, food and feed products.

In an embodiment of the present disclosure, the product inspection layer is further used for generating a metabolome database according to the first inspection data.

In an embodiment of the present disclosure, the first inspection data is original inspection data of an inspection sample of the biological product generated by an inspection agency.

In an embodiment of the present disclosure, the second inspection data includes a product identification code and a product inspection result presented in a form of product quality report data and/or product authenticity report data.

In an embodiment of the present disclosure, the biological metabonomics method includes at least one of metabolome fingerprint, metabolome global analysis, and targeted metabolite analysis.

In an embodiment of the present disclosure, the first inspection data and the second inspection data are stored separately.

According to a second aspect, an embodiment of the present disclosure also provides a biological product monitoring method, which is applied to a block chain system including a product inspection layer where a preset inspection standard is stored. The biological product monitoring method includes: acquiring first inspection data of a biological product by using the product inspection layer, where the first inspection data is generated based on the preset inspection standard, and the preset inspection standard is an inspection standard based on a biological metabonomics method; and performing an analysis of the first inspection data to generate second inspection data of the biological product by using the product inspection layer.

In an embodiment of the present disclosure, block chain system further includes a data application layer in communication with the product inspection layer and after the performing an analysis of the first inspection data to generate second inspection data of the biological product by using the product inspection layer, the biological product monitoring method further includes: generating a product inspection code according to the second inspection data by using the product inspection layer; and transmitting the product inspection code, a product circulation code generated based on product circulation information of the biological product, and a product registration code generated based on product registration information of the biological product to the data application layer to generate a transaction contract by using the data application layer.

In an embodiment of the present disclosure, the block chain system further includes a product circulation layer in communication with the data application layer, and before the transmitting a product inspection code, a product circulation code generated based on product circulation information, and a product registration code generated based on product registration information to the data application layer to generate a transaction contract by using the data application layer, the biological product monitoring method further includes: storing the product circulation information and generate the product circulation code according to the product circulation information by using the product circulation layer.

In an embodiment of the present disclosure, the block chain system further includes a product registration layer in communication with the data application layer, and before the transmitting a product inspection code, a product circulation code generated based on product circulation information, and a product registration code generated based on product registration information to the data application layer to generate a transaction contract by using the data application layer, the biological product monitoring method further includes: storing the product registration information and generate the product registration code according to the product registration information by using the product registration layer.

In an embodiment of the present disclosure, after the transmitting the product inspection code, a product circulation code generated based on product circulation information of the biological product, and a product registration code generated based on product registration information of the biological product to the data application layer to generate a transaction contract by using the data application layer, the biological product monitoring method further includes at least one of the following steps: acquiring a transaction demand of a third user, and performing a transaction operation according to the transaction demand and the transaction contract; acquiring a viewing demand of a fourth user, and performing a viewing operation according to the viewing demand; and acquiring an application demand of a fifth user, and performing a data application operation according to the application demand.

In an embodiment of the present disclosure, after the using the product inspection layer to acquire the first inspection data of the biological product, the biological product monitoring method further includes: generating a metabolome database according to the first inspection data by using the product inspection layer.

According to a third aspect, an embodiment of the present disclosure also provides a biological product monitoring device, which is applied to a block chain system including a product inspection layer where a preset inspection standard are stored. The biological product monitoring device includes: a first module, configured to use the product inspection layer to generate a product inspection code according to the second inspection data, where the first inspection data is generated based on a preset inspection standard, and the preset inspection standard is an inspection standard based on a biological metabonomics method; and a second module, configured to use the product inspection layer to perform analysis of the first inspection data to generate second inspection data of the biological product.

According to a fourth aspect, an embodiment of the present disclosure also provides a non-transitory computer-readable storage medium, where a computer program is stored for performing the biological product monitoring method mentioned in any of the above embodiments.

According to a fifth aspect, an embodiment of the present disclosure also provides an electronic device, which includes a processor and a memory for storing the executable instructions of the processor, and the processor is used for implementing the biological product monitoring method mentioned in any of the above embodiments.

The block chain system provided by the embodiments of the present disclosure, by presetting inspection standards based on a biological metabonomics method in a product inspection layer, combines the block chain system with the biological metabolomics method. Compared with the prior art, the block chain system provided by the embodiments of the present disclosure not only has the ability to detect product quality of biological products, which resolves a trust issue of product quality and reduces monitoring pressure, but also can effectively improve data utilization, enrich dimensions of data mining, reduce useless data, and then realize energy conservation and high efficiency. In addition, the block chain system provided by the embodiments of the disclosure can effectively improve fairness of competition between inspection agencies, thereby providing a prerequisite for continuously improving an inspection level of inspection agencies and ensuring credibility of inspection.

The biological product monitoring method provided by the embodiments of the present disclosure solves a quality monitoring problem of biological products by using the block chain system which includes a product inspection layer, and provides a prerequisite for a social quality supervision mechanism and data sharing of biological products.

### BRIEF DESCRIPTION OF THE DRAWINGS

FIG. 1 is a structural schematic diagram of a block chain system according to an exemplary embodiment of the present disclosure.

FIG. 2 is a flowchart of determining first inspection data of a biological product according to an exemplary embodiment of the present disclosure.

FIG. 3 is a flowchart of determining first inspection data of a biological product according to another exemplary embodiment of the present disclosure.

FIG. 4 is a flowchart of a practical application of a block chain system according to an exemplary embodiment of the present disclosure.

FIG. 5 is a flowchart of performing an analysis of first inspection data to generate second inspection data of a biological product according to an exemplary embodiment of the present disclosure.

FIG. 6 is a structural diagram of a block chain system according to another exemplary embodiment of the present disclosure.

FIG. 7 is a flowchart of a biological product monitoring method according to an exemplary embodiment of the present disclosure.

FIG. 8 is a flowchart of a biological product monitoring method according to another exemplary embodiment of the present disclosure.

FIG. 9 is a flowchart of a biological product monitoring method according to another exemplary embodiment of the present disclosure.

FIG. 10 is a flowchart of a biological product monitoring method according to another exemplary embodiment of the present disclosure.

FIG. 11 is a structure diagram of a biological product monitoring device according to an exemplary embodiment of the present disclosure.

FIG. 12 is a structural diagram of an electronic device according to an exemplary embodiment of the present disclosure.

### DETAILED DESCRIPTION OF THE EMBODIMENTS

In the following, exemplary embodiments according to the present disclosure will be described in detail with reference to accompanying drawings. Obviously, the described embodiments are only a part of the embodiments of the disclosure, not all of the embodiments of the disclosure. It should be understood that the disclosure is not limited by the exemplary embodiments described here.

FIG. 1 is a structural schematic diagram of a block chain system according to an exemplary embodiment of the present disclosure. As shown in FIG. 1, a block chain system 100 provided by the embodiment of the present disclosure includes a product inspection layer 110. The product inspection layer 110 is used for determining first inspection data of a biological product, and performing an analysis of the first inspection data to generate second inspection data of the biological product. Therein, a preset inspection standard is stored in the product inspection layer 110 and the preset inspection standard is an inspection standard based on a biological metabonomics method.

Exemplarily, the biological product includes at least one of agricultural products, reprocessed agricultural products, traditional Chinese medicine products, reprocessed traditional Chinese medicine products, food and feed products.

Exemplarily, the first inspection data is original inspection data of an inspection sample of the biological product generated by an inspection agency.

Exemplarily, an inspection contract is stored in the product inspection layer 110, and the second inspection data is generated after the first inspection data is analyzed according to the inspection contract. For example, the second inspection data includes a product identification code, a product inspection result and other data. Therein, the product inspection result is presented in a form of product quality report data and/or product authenticity report data.

The product quality of biological products may be inspected effectively through the inspection and analysis of the biological product based on the biological metabonomics method and then a problem of quality identification of biological products may be solved. In addition, a metabolome comparative analysis based on the biological metabonomics method may be performed not only between different inspection batches of the same sample, but also between different products, so as to achieve the purpose of improving the utilization of data.

The block chain system provided by the embodiments of the present disclosure, by presetting the inspection standard based on the biological metabonomics method in the product inspection layer, combines the block chain system with the biological metabolomics method. Compared with the prior art, the block chain system provided by the embodiments of the present disclosure not only has the ability to detect the product quality of biological products, which resolves a trust issue of product quality and reduces monitoring pressure, but also can effectively improve the data utilization, enrich the dimensions of data mining, reduce useless data, and then realize energy conservation and high efficiency. In addition, the block chain system provided by the embodiments of the disclosure can effectively improve fairness of competition between inspection agencies, thereby providing a prerequisite for continuously improving the inspection level of an inspection agency and ensuring the credibility of inspection.

In an embodiment of the present disclosure, the biological metabonomics method includes metabolome fingerprint, metabolome global analysis, and targeted metabolite analysis, etc.

In an embodiment of the present disclosure, the first inspection data and the second inspection data in the product inspection layer 110 are stored separately, so as to improve application diversities of the first inspection data and the second inspection data, and thus improve an expansion diversity of the block chain system. For example, when the first inspection data is the original inspection data generated by the inspection agency for an inspection sample of the biological product, after the original inspection data and the second inspection data are stored separately, the original inspection data can be regarded as a bottom metabolome database, and then diverse applications may be performed according to the original inspection data. For example, the original inspection data may be used to perform a corresponding analysis for the purpose of product optimization research or other scientific research.

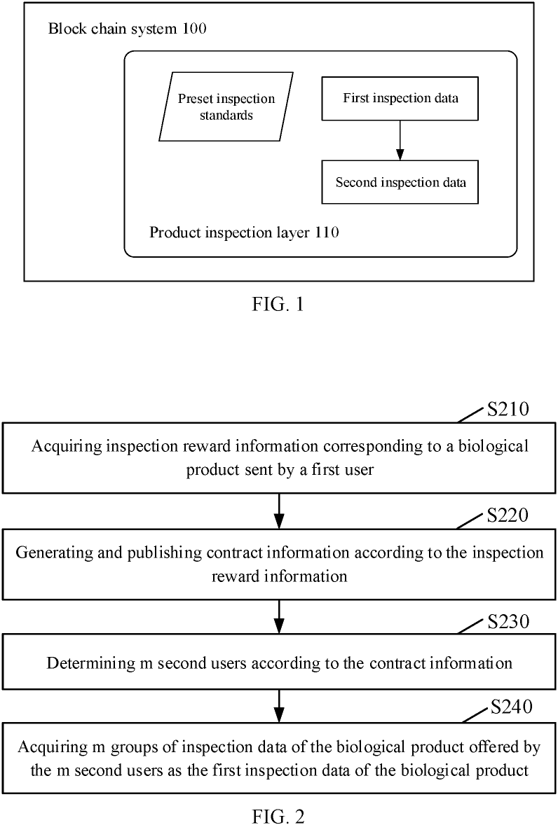

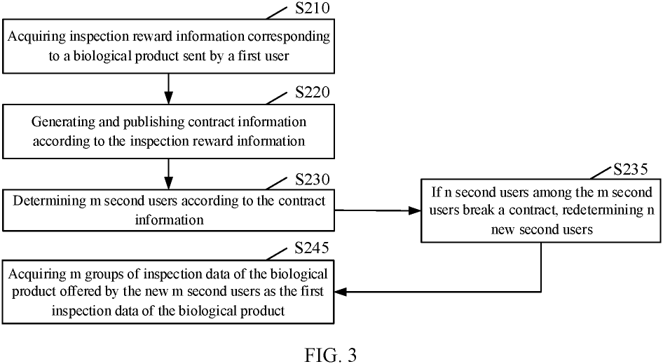

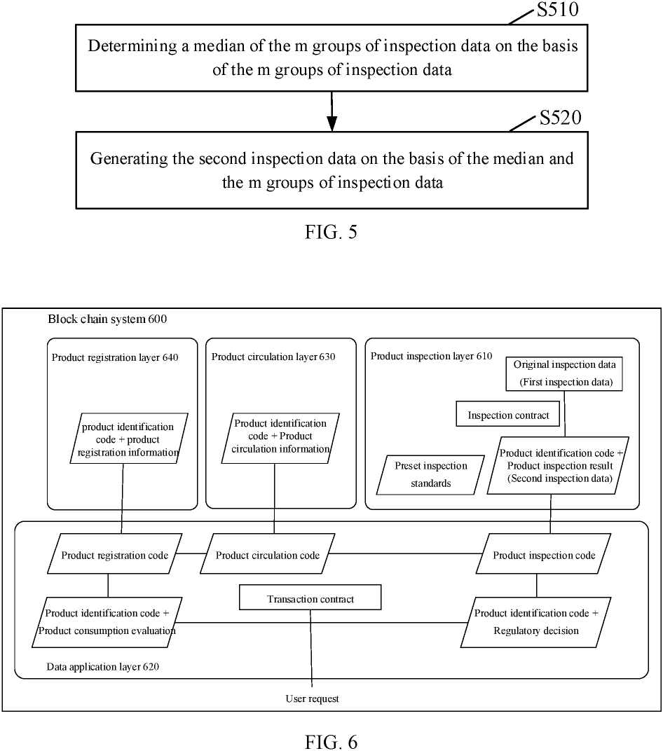

Exemplarily, the function the product inspection layer 110 relating to the step of determining first inspection data of a biological product, and performing an analysis of the first inspection data to generate second inspection data of the biological product, is realized with the help of the inspection contract stored in the product inspection layer 110. The specific implementation steps of the above functions are described with reference to FIG. 2, FIG. 3 and FIG. 5 in the following.

In some embodiments, the block chain system includes a processor and a memory used for storing executable instructions of the processor, where the processor includes the product inspection layer storing the preset inspection standard mentioned above.

In addition, the processor may further include the data application layer in communication with the product inspection layer, the product circulation layer in communication with the data application layer, and the product registration layer in communication with the data application layer.

FIG. 2 is a flowchart of determining first inspection data of a biological product according to an exemplary embodiment of the present disclosure. As shown in FIG. 2, in the embodiment of the present disclosure, the determining first inspection data of a biological product includes the following steps.

Step S210, acquiring inspection reward information corresponding to the biological product sent by a first user.

Exemplarily, the first user is a demand user with a demand for an inspection of the biological product.

The demand user may demand for the inspection at any node between the completion of production of the biological product and consumption of consuming user. By comparing inspection results of different nodes, reasons for changes in the quality of the biological product may be determined, and then solutions may be developed in time according to the reasons to optimize the quality of the biological product.

In an embodiment of the present disclosure, the inspection reward information includes reward amount, number of inspection users and other information. Therein, the inspection user refers to the user who can perform inspection operation of the biological product.

Optionally, the number of the inspection users is greater than or equal to three.

Step S220, generating and publishing contract information according to the inspection reward information.

Exemplarily, the contract information includes information such as contract period. The block chain system intelligently calculates a contract period and other information according to the inspection reward information sent by the first user to generate contract information and publish it.

Step S230, determining m second users according to the contract information.

Exemplarily, the second user is the inspection user with inspection capability for the biological product.

After the block chain system publishes the contract information, the inspection users grab orders according to the contract information. When the number of the inspection users who have grabbed the orders reaches a preset number (the preset number is m), the order grabbing ends. After the order grabbing ends, the demand user transfers the inspection samples of the biological product to the inspection users who have successfully grabbed the order, so that the inspection users who have successfully grabbed the order may perform the inspection operation according to the inspection sample.

Exemplarily, when the number of the inspection users who have successfully grabbed the order fails to reach the preset number, the contract is terminated.

Step S240, acquiring m groups of inspection data of the biological product offered by the m second users as the first inspection data of the biological product.

Exemplarily, according to the contract published by the block chain system, the inspection users who have successfully grabbed the order (namely the m second users) perform the inspection operation on the inspection sample during the contract period to generate inspection data (namely the m groups of inspection data), and upload the inspection data to the product inspection layer of the block chain system.

The block chain system provided by the embodiments of the present disclosure realizes the purpose of determining the first inspection data of the biological product through the steps described above. Since the first inspection data is formed according to the m groups of inspection data of the m second users, a single second user is unable to directly determine the inspection result (namely the second inspection data). Therefore, the embodiments of the present disclosure may reduce a probability of which a single second user falsifies inspection data, and further improve the inspection credibility.

FIG. 3 is a flowchart of determining first inspection data of a biological product according to another exemplary embodiment of the present disclosure. The embodiment shown in FIG. 3 of the present disclosure is extended on the basis of the embodiment shown in FIG. 2 of the present disclosure. The differences between the embodiment shown in FIG. 3 and the embodiment shown in FIG. 2 are highlighted below, and the similarities will not be repeated.

As shown in FIG. 3, in the embodiment of the present disclosure, after the determining m second users according to the contract information, the determining first inspection data of a biological product further includes the following steps.

Step S235, if n second users among the m second users break a contract, re-determining n new second users.

The n is a positive integer less than or equal to m. The n new second users and (m-n) second users without breach of the contract constitute new m second users.

Therein, the acquiring m groups of inspection data of the biological product offered by the m second users as the first inspection data of the biological product includes the following steps.

Step S245, acquiring m groups of inspection data of the biological product offered by the new m second users as the first inspection data of the biological product.

The block chain system provided by the embodiments of the present disclosure may effectively avoid a forced termination of the contract due to the default of some of the m second users, thereby further improving the stability of the inspection.

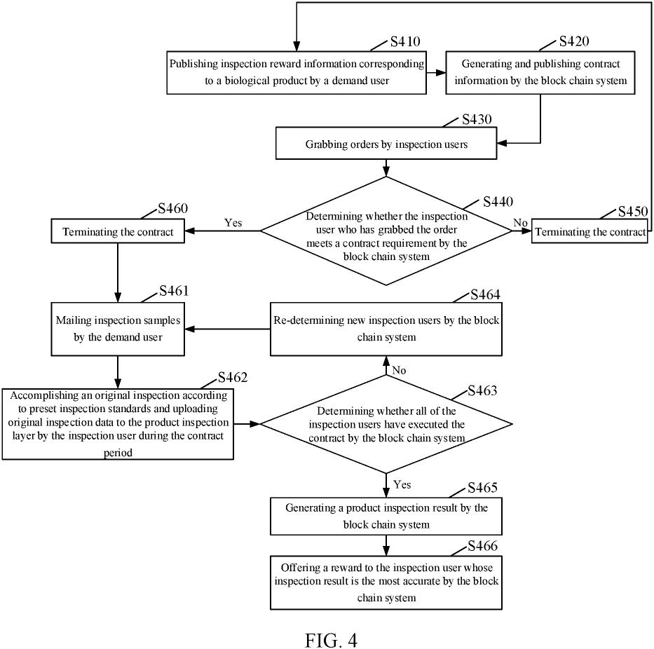

The specific implementation flow of the embodiments shown in FIG. 2 and FIG. 3 is described in detail below with reference to FIG. 4.

FIG. 4 is a flowchart of a practical application of a block chain system according to an exemplary embodiment of the present disclosure. As shown in FIG. 4, the practical application process of the block chain system provided by the embodiment of the present disclosure includes the following steps.

Step S410, publishing inspection reward information corresponding to a biological product by a demand user.

Step S420, generating and publishing contract information by the block chain system.

Step S430, grabbing orders by inspection users.

Step S440, determining whether the inspection user who has grabbed the order meets a contract requirement by the block chain system.

In the step S440, if the block chain system determines that the inspection user who has grabbed the order meets the contract requirement, step S460 is executed, that is, the contract is established; if the block chain system determines that the inspection user who has grabbed the order does not meet the contract requirement, step S450 is executed, that is, the contract is terminated.

Step S450, terminating the contract by the block chain system.

Step S460, establishing the contract by the block chain system.

In the actual application process, the demand user publishes the inspection reward information corresponding to the biological product. The block chain system acquires the inspection reward information published by the demand user, generates the contract information according to the inspection reward information and publishes it. And then the inspection users grab the order according to the published contract information. The block chain system determines whether the inspection user who has grabbed the order meets the contract requirement. And if the requirement is met, the contract is established and executed; if the requirements are not met, the contract is terminated and will not be executed.

An execution process after the establishment of the contract is described below with reference to steps S461 to S466.

Step S461, mailing inspection samples by the demand user.

Step S462, accomplishing an original inspection according to a preset inspection standard and uploading original inspection data to the product inspection layer by the inspection user during the contract period.

Step S463, determining whether all of the inspection users have executed the contract by the block chain system.

In the step S463, if the block chain system determines that not all of the inspection users who have successfully grabbed the order have executed the contract, step S464 is executed, that is, the block chain system redetermines new inspection users and the demand user mails inspection samples to the new inspection users; if the block chain system determines that all of the inspection users who have successfully grabbed the order have executed the contract, step S465 is executed, that is, the block chain system generates a product inspection result.

Step S464, re-determining new inspection users by the block chain system.

Step S465, generating a product inspection result by the block chain system.

Step S466, offering a reward to the inspection user whose inspection result is the most accurate by the block chain system.

Exemplarily, firstly, the product inspection layer of the block chain system performs an analysis of the original inspection data generated by the inspection users to obtain a final product inspection result; then, the block chain system compares the final product inspection result with the original inspection data of the inspection users to determine the inspection user whose inspection result is the most accurate, and determines that the inspection user whose inspection result is the most accurate get the reward.

In the actual application process, when the contract is established, the demand user mails the inspection samples to the inspection users who have successfully grabbed the order. Then, during the contract period, the inspection users who have successfully grabbed the order accomplish the original inspection according to the preset inspection standard and uploads the original inspection data to the product inspection layer of the block chain system. In addition, the block chain system determines whether all of the inspection users have executed the contract. If the block chain system determines that not all of the inspection users who have successfully grabbed the order have executed the contract, the block chain system redetermines new inspection users; and if all of the inspection users have executed the contract, the block chain system generates the product inspection result according to the original inspection data uploaded by the inspection users who have successfully grabbed the order, and determines that the most accurate inspection user gets the reward from the demand user.

FIG. 5 is a flowchart of performing an analysis of first inspection data to generate second inspection data of a biological product according to an exemplary embodiment of the present disclosure. The embodiment shown in FIG. 5 of the present disclosure is extended on the basis of the embodiment shown in FIG. 2 of the present disclosure. The differences between the embodiment shown in FIG. 5 and the embodiment shown in FIG. 2 are highlighted below, and the similarities will not be repeated.

As shown in FIG. 5, in the embodiment of the present disclosure, the step of the performing an analysis of the first inspection data to generate second inspection data of the biological product includes the following steps.

Step S510, determining a median of the m groups of inspection data according to the m groups of inspection data.

Step S520, generating the second inspection data according to the median and the m groups of inspection data. Therein, the second inspection data comprises inspection analysis data and product inspection result data of the m groups of inspection data.

Median is a basic analysis data for statistical analysis of parallel data, not the only inspection analysis data in the second inspection data. For example, the product inspection layer may performs inspection and analysis operations on the m groups of inspection data using other methods to obtain corresponding inspection and analysis data.

The block chain system provided by the embodiments of the present disclosure further improves the accuracy of the second inspection data by determining the median of the m groups of the inspection data, and then generating the second inspection data according to the median and the m groups of inspection data, thereby improving the inspection accuracy of the biological product.

FIG. 6 is a structural diagram of a block chain system according to another exemplary embodiment of the present disclosure. The embodiment shown in FIG. 6 of the present disclosure is extended on the basis of the embodiment shown in FIG. 1 of the present disclosure. The differences between the embodiment shown in FIG. 6 and the embodiment shown in FIG. 1 are highlighted below, and the similarities will not be repeated.

As shown in FIG. 6, the block chain system 600 provided by the embodiment of the present disclosure includes a product inspection layer 610, a data application layer 620 in communication with the product inspection layer 610, a product circulation layer 630 in communication with the data application layer 620, and a product registration layer 640 in communication with the data application layer 620.

The relevant description of the product inspection layer 610 can be seen in the embodiment shown in FIG. 1. Therein, the first inspection data in the product inspection layer 610 is original inspection data of the inspection samples offered by the inspection users who have successfully grabbed the order. The second inspection data in the product inspection layer 610 includes a product identification code, a product inspection result and other data.

The product identification code refers to identification information that can uniquely represent the product and can correspond to the product one by one.

In the embodiment of the disclosure, the product inspection layer 610 is also used for generating the product inspection code according to the second inspection data and transmitting the product inspection code to the data application layer 620.

The data application layer 620 is used for acquiring the product inspection code generated based on the second inspection data, the product circulation code generated based on product circulation information of the biological product and the product registration code generated based on product registration information of the biological product, and generating a transaction contract according to the product inspection code, the product circulation code and the product registration code. In addition, the data application layer 620 also stores data such as product consumption evaluation, regulatory decisions, transaction information and other data. Optionally, the product consumption evaluation is uploaded to the data application layer 620 by the consuming users.

Optionally, the data such as the product consumption evaluation, regulatory decisions are also bound with the product identification code separately to facilitate data tracing operation in the later period.

Optionally, the transaction contract in the data application layer 620 may be used to determine whether to continue or suspend the contract according to the second inspection data corresponding to the product inspection code, and determine a defaulting party of the contract suspension.

In the embodiment of the disclosure, the product circulation code and the product registration code acquired by the data application layer 620 are generated based on the product circulation layer 630 and the product registration layer 640 respectively. Specifically, the product circulation layer 630 is used for storing a product identification code and the product circulation information, generating the product circulation code according to the product identification code and the product circulation information, and transmitting the product circulation code to the data application layer 620. The product registration layer 640 is used for storing the product identification code and the product registration information, generating the product registration code according to the product identification code and the product registration information, and transmitting the product registration code to the data application layer 620.

The product circulation layer 630 and the product registration layer 640 mentioned above may be deleted. After deletion, the product circulation code and the product registration code may be input to the data application layer 620 by external institutions.

In an embodiment of the present disclosure, the block chain system 600 may perform priority weighting operation according to user behavior of different users to generate user credit evaluation. For example, the user behavior includes at least one of implement and default records of users, user service time, and accuracy records.

In an embodiment of the present disclosure, the block chain system 600 further includes an user layer, used for storing user information and providing the user information for other layers (such as the product inspection layer 610, the data application layer 620, the product circulation layer 630 and product registration layer 640). For example, the user layer may store the user information of production users, circulation users, inspection users, consuming users and supervision users.

Optionally, the block chain system 600 mentioned in the embodiments of the present disclosure is based on an alliance chain architecture, so as to improve an operation efficiency of the block chain system 600, especially an operation efficiency of inspection of the product inspection layer 610.

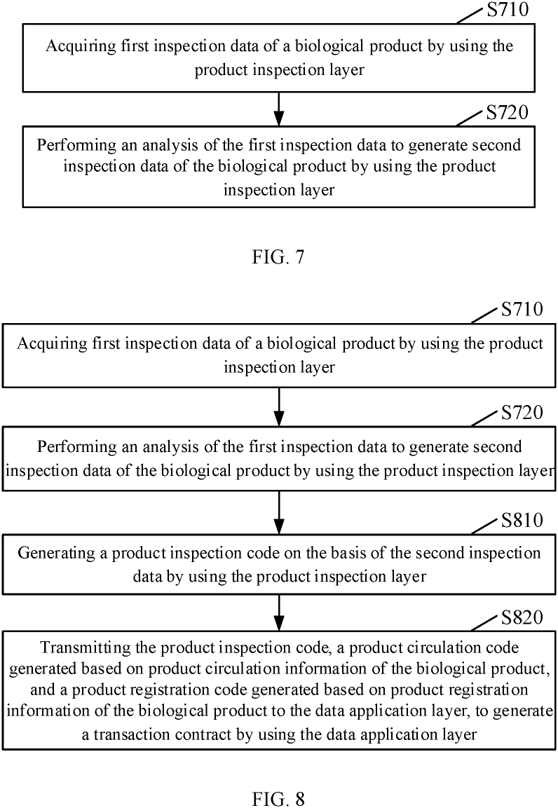

The application scenario embodiments of the block chain system mentioned in the above embodiments are shown below with reference to FIG. 7 to FIG. 10. Specifically, the application scenario of the embodiments shown in FIG. 7 to FIG. 10 is a biological product monitoring scenario.

The following definitions of related terms in the embodiments shown in FIG. 7 to FIG. 10 may be explained with reference to the above embodiments of the block chain system and will not be repeated in order to prevent redundancy.

FIG. 7 is a flowchart of a biological product monitoring method according to an exemplary embodiment of the present disclosure. Specifically, the biological product monitoring method provided by the embodiments of the present disclosure is applied to a block chain system that includes a product inspection layer which stores a preset inspection standard.

As shown in FIG. 7, the biological product monitoring method provided by the embodiment of the present disclosure includes the following steps.

Step S710, acquiring first inspection data of a biological product by using the product inspection layer.

Exemplarily, the first inspection data is uploaded to the product inspection layer by inspection users.

Step S720, performing an analysis of the first inspection data to generate second inspection data of the biological product by using the product inspection layer.

In the actual application process, firstly, the product inspection layer is used to acquire the first inspection data of the biological product and then perform the analysis of the first inspection data to generate the second inspection data of the biological product.

The biological product monitoring method provided by the embodiments of the present disclosure solves a quality monitoring problem of biological products by using the block chain system which includes the product inspection layer, and provides a prerequisite for a social quality supervision mechanism and data sharing of biological products.

Optionally, in another embodiment of the disclosure, the biological product monitoring method further includes: acquiring the preset inspection standard determined by regulatory users according to supervision authority by using the product inspection layer.

FIG. 8 is a flowchart of a biological product monitoring method according to another exemplary embodiment of the present disclosure. The embodiment shown in FIG. 8 of the present disclosure is extended on the basis of the embodiment shown in FIG. 7 of the present disclosure. The differences between the embodiment shown in FIG. 8 and the embodiment shown in FIG. 7 are highlighted below, and the similarities will not be repeated.

Specifically, in the embodiment of the disclosure, the block chain system further includes a data application layer in communication with the product inspection layer. As shown in FIG. 8, in the embodiment of the present disclosure, after the performing an analysis of the first inspection data to generate second inspection data of the biological product through the product inspection layer, the biological product monitoring method further includes the following steps.

Step S810, generating a product inspection code according to the second inspection data by using the product inspection layer.

Step S820, transmitting the product inspection code, a product circulation code generated based on product circulation information of the biological product, and a product registration code generated based on product registration information of the biological product to the data application layer, to generate a transaction contract by using the data application layer.

In the actual application process, firstly, the product inspection layer is used to acquire the first inspection data of the biological product and perform the analysis of the first inspection data to generate the second inspection data of the biological product. Then, the product inspection layer is used to generate the product inspection code according to the second inspection data and transmit the product inspection code, a product circulation code generated based on the product circulation information of biological products and a product registration code generated based on the product registration information of biological products to the data application layer to generate the transaction contract by using the data application layer.

The biological product monitoring method provided by the embodiments of the present disclosure uses the data application layer to improve application functions (including transaction functions, etc.) of the block chain system, thereby further improving user experience.

Optionally, in another embodiment of the disclosure, the biological product monitoring method further includes: acquiring regulatory decisions determined by the regulatory user by using the data application layer. In the actual application process, data pre-warning conditions may be set according to a regulatory policy. Once the block chain system acquires information that meets the pre-warning conditions, the information will be separately marked and sent to the regulatory user, who will authorize to complete the regulatory decision and publish the decision to the data application layer.

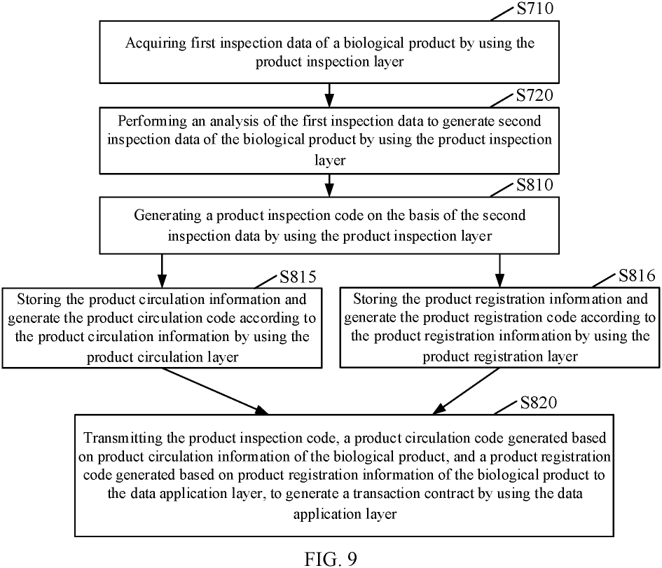

FIG. 9 is a flowchart of a biological product monitoring method according to another exemplary embodiment of the present disclosure. The embodiment shown in FIG. 9 of the present disclosure is extended on the basis of the embodiment shown in FIG. 8 of the present disclosure. The differences between the embodiment shown in FIG. 9 and the embodiment shown in FIG. 8 are highlighted below, and the similarities will not be repeated.

Specifically, in the embodiment of the present disclosure, the block chain system further includes a product circulation layer and a product registration layer that communicate with the data application layer. As shown in FIG. 9, in the embodiment of the present disclosure, before the transmitting the product inspection code, the product circulation code generated based on the product circulation information of biological products, and the product registration code generated based on the product registration information of biological products to the data application layer, to generate a transaction contract by using the data application layer, the biological product monitoring method further includes the following steps.

Step S815, storing the product circulation information and generate the product circulation code according to the product circulation information by using the product circulation layer to.

Exemplarily, the product circulation information is uploaded to the product circulation layer by circulation users. Therein, the circulation users include but are not limited to storage users, transportation users, sales users and reproduction users of the biological product.

Optionally, the product circulation code is generated according to the product circulation information and product identification code, so as to generate the product circulation code that can be used to trace the product circulation information of the biological product according to the product identification code.

Step S816, storing the product registration information and generate the product registration code according to the product registration information by using the product registration layer.

Exemplarily, the product registration information is uploaded to the product registration layer by the production user.

Optionally, the product registration code is generated according to the product registration information and the product identification code, so as to generate the product registration code that can trace the product registration information of the biological product according to the product identification code.

The biological product monitoring method provided by the embodiments of the present disclosure uses the product circulation layer and the product registration layer that communicate with the data application layer to realize the purpose of storing the product circulation information and the product registration information, and generating the product circulation code and the product registration code respectively according to the product circulation information and the product registration information. Compared with the embodiment shown in FIG. 8, the embodiment of the present disclosure may further improve scalability of the block chain system.

It is possible to execute only one of the step S815 and the step S816 in the embodiment shown in FIG. 9. Correspondingly, the block chain system may only have one of the product circulation layer and the product registration layer.

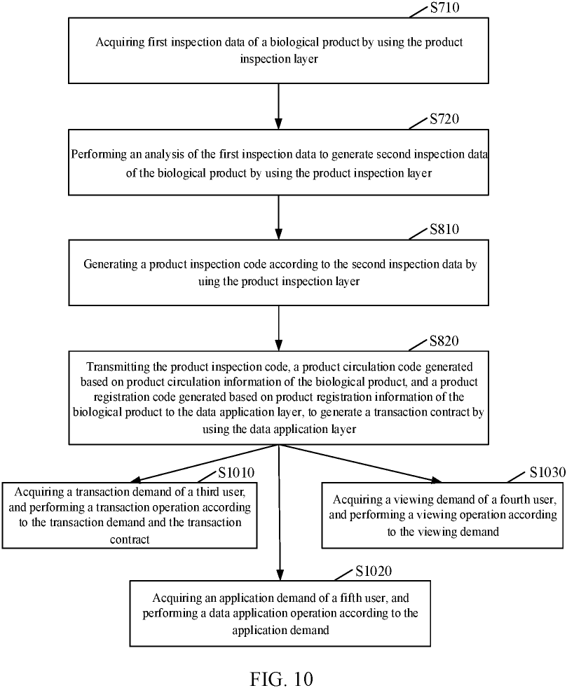

FIG. 10 is a flowchart of a biological product monitoring method according to another exemplary embodiment of the present disclosure. The embodiment shown in FIG. 10 of the present disclosure is extended on the basis of the embodiment shown in FIG. 8 of the present disclosure. The differences between the embodiment shown in FIG. 10 and the embodiment shown in FIG. 8 are highlighted below, and the similarities will not be repeated.

As shown in FIG. 10, in the embodiment of the present disclosure, after the transmitting the product inspection code, a product circulation code generated based on product circulation information of the biological product, and a product registration code generated based on product registration information of the biological product to the data application layer, to generate a transaction contract by using the data application layer, the biological product monitoring method further includes at least one of the following steps.

Step S1010, acquiring a transaction demand of a third user, and performing a transaction operation according to the transaction demand and the transaction contract.

Exemplarily, the third user is an user with the transaction demand, including the inspection user and the demand user.

Step S1020, acquiring a viewing demand of a fourth user, and performing a viewing operation according to the viewing demand.

Exemplarily, the fourth user is an user with the viewing demand of data. For example, the fourth user may check the corresponding product registration information, product circulation information and product inspection information according to the product registration code, the product circulation code and the product inspection code of the data application layer.

Step S1030, acquiring an application demand of a fifth user, and performing an application operation according to the application demands.

Exemplarily, the fifth user is an user with the application demand of data. For example, the supervision user may conduct supervision and management of product quality or a standard optimization research according to the data stored in the data application layer. For another example, the production users may conduct a customized product research or a product optimization research according to the data stored in the data application layer.

The biological product monitoring method provided by the embodiments of the present disclosure can further enrich the application functions of the block chain system, and further improve the user experience.

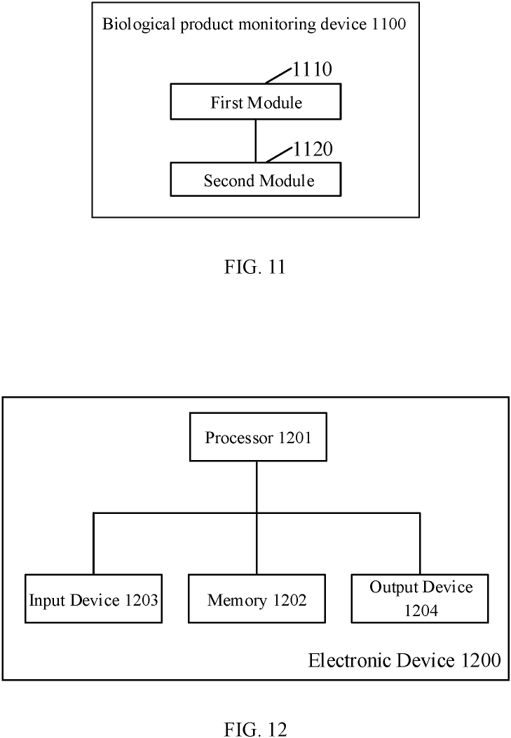

FIG. 11 is a structure diagram of a biological product monitoring device according to an exemplary embodiment of the present disclosure. As shown in FIG. 11, the biological product monitoring device 1100 provided by the embodiment of the present disclosure is applied to a block chain system including a product inspection layer which stores a preset inspection standard, and includes:
a first module 1110, configured to use the product inspection layer to acquire first inspection data of a biological product;
a second module 1120, configured to use the product inspection layer to perform an analysis of the first inspection data to generate second inspection data of the biological product.

Another embodiment of the present disclosure is extended on the basis of the embodiment shown in FIG. 11. In the embodiment of the disclosure, the block chain system further includes a data application layer that communicates with the product inspection layer, and the biological product monitoring device 1100 further includes:
a third module, configured to use the product inspection layer to generate a product inspection code according to the second inspection data;
a fourth module, configured to transmit the product inspection code, a product circulation code generated based on product circulation information of the biological product, and a product registration code generated based on product registration information of the biological product to the data application layer to generate a transaction contract by using the data application layer.

Optionally, in another embodiment of the present disclosure, the block chain system further includes a product circulation layer and/or a product registration layer in communication with the data application layer, and the biological product monitoring device 1100 further includes:

a fifth module, configured to use the product circulation layer to store the product circulation information and generate the product circulation code according to the product circulation information, and/or use the product registration layer to store the product registration information and generate the product registration code according to the product registration information.

Optionally, in another embodiment of the present disclosure, the biological product monitoring device 1100 further includes:

a sixth module, configured to acquire a transaction demand of a third user and perform a transaction operation according to the transaction demand and the transaction contract; and/or, acquire a viewing demand of a fourth user and perform a viewing operation according to the viewing demand; and/or, acquire an application demand of a fifth user and perform an application operation of the data according to the application demand.

The operation and functions of the first module 1110, the second module 1120, the third module, the fourth module, the fifth module and the sixth module mentioned in the above device embodiments can be explained with reference to the method embodiments shown in FIG. 7 to FIG. 10, and will not be repeated here to avoid repetition.

Hereinafter, an electronic device according to an embodiment of the present disclosure will be described with reference to FIG. 12. FIG. 12 is a structural diagram of an electronic device according to an exemplary embodiment of the present disclosure.

As shown in FIG. 12, the electronic device 1200 includes one or more processors 1201 and a memory 1202.

The processor 1201 may be a central processing unit (CPU) or other form of processing unit with data processing capability and/or instruction executing capabilities, and may control other components in the electronic device 1200 to perform desired functions.

Memory 1202 may include one or more computer program products, which may include various forms of computer-readable storage media, such as volatile memory and/or non-volatile memory. The volatile memory may include, for example, random access memory (RAM) and/or cache memory. The non-volatile memory may include, for example, a read-only memory (ROM), a hard disk, a flash memory, and the like. One or more computer program instructions may be stored on the computer-readable storage medium, and the processor 1201 may execute the program instructions to implement steps in the biological product monitoring method and/or other desired functions of the embodiments of the present disclosure described above. Various contents such as the first inspection data may also be stored in the computer-readable storage medium.

In one example, the electronic device 1200 may also include an input apparatus 1203 and an output device 1204, which are interconnected by a bus system and/or other forms of connection mechanisms (not shown).

The input device 1203 may include, for example, a keyboard, a mouse, a microphone, and the like.

The output device 1204 can output various information to the outside, including the second inspection data and the like. The output device 1204 may include, for example, a display, a communication network, a speaker, and a remote output device connected thereto.

Of course, to simplify, only some of the components in the electronic device 1200 related to the present disclosure are shown in FIG. 12, and components such as buses, input/output interfaces, and the like are omitted. In addition, the electronic device 1200 may also include any other suitable components, depending on the specific application.

In addition to the above methods and devices, embodiments of the present disclosure may also be computer program products, including computer program instructions that, cause the processor to perform the steps in the biological product monitoring method described in the above “exemplary methods” section of the description according to various embodiments of the present disclosure when the computer program instructions are run by the processor.

The computer program product can use any combination of one or more programming languages to write program code for performing the operation of the embodiments of the present disclosure. The programming language includes object-oriented programming languages, such as Java, C++, etc., and also includes conventional procedural programming languages, such as “C” language or similar programming languages. The program code can be executed entirely on the user’s computing device, partially on the user device, as an independent software package, partially on the user computing device, partially on the remote computing device, or completely on the remote computing device or server.

In addition, the embodiments of the present disclosure can also be computer readable storage media, on which computer program instructions are stored, and the computer program instructions cause the processor to execute the steps in the biological product monitoring method according to various embodiments of the present disclosure described in the above “exemplary method” section of the description when the computer program instructions are run by the processor.

The computer-readable storage medium can adopt any combination of one or more readable media. The readable medium may be a readable signal medium or a readable storage medium. Readable storage media may include, for example, but are not limited to, electrical, magnetic, optical, electromagnetic, infrared, or semiconductor systems, devices, or devices, or any combination thereof. More specific examples (a non-exhaustive list) of readable storage media include: an electrical connection having one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The basic principles of the disclosure have been described above in conjunction with specific embodiments. However, it should be pointed out that the advantages, superiority, effects, etc. mentioned in the disclosure are only examples rather than limitations, and these advantages, superiority, effects, etc. are considered as necessary for each embodiment of the disclosure. In addition, the specific details disclosed above are only for the purpose of example and easy to understand, rather than limiting. The above details do not limit the disclosure to be implemented by using the above specific details.

The block diagrams of equipment, apparatus, devices and systems referred to in the present disclosure are only illustrative examples and are not intended to require or imply that connections, arrangements and configurations must be made in the manner shown in the block diagrams. As will be recognized by those skilled in the art, these equipment, apparatus, devices and systems may be connected, arranged and configured in any manner. Words such as “including”, “containing”, “having”, and etc. are open words, referring to “including but not limited to”, and can be used interchangeably therewith. The words “or” and “and” refer to and are used interchangeably with the word“ and/or ”, unless the upper and lower civilizations clearly indicate that this is not the case. The word “such as” used here refers to the phrase “such as but not limited to” and can be used interchangeably with it.

It should also be noted that in the device, equipment and method of the present disclosure, each component or each step can be decomposed and/or recombined. These isaggregations and/or recombinations should be considered as equivalents of the present disclosure.

The above description of the disclosed aspects is provided to enable any person skilled in the art to make or use the disclosure. Various modifications to these aspects will be readily apparent to those skilled in the art, and the general principles defined herein may be applied to other aspects without departing from the scope of the disclosure. Therefore, the present disclosure is not intended to be limited to the aspects shown herein, but is to be accorded the widest scope consistent with the principles and novel features disclosed herein.

The foregoing description has been presented for the purposes of illustration and description. In addition, this description is not intended to limit the embodiments of the present disclosure to the form disclosed herein. Although a number of example aspects and embodiments have been discussed above, those skilled in the art will recognize certain variations, modifications, changes, additions and sub combinations thereof.

What is claimed is:

1. A block chain system, comprising:
a processor; and
a memory, wherein an executable instruction of the processor is stored in the memory and the processor comprises a product inspection layer wherein a preset inspection standard is stored, used for determining first inspection data of a biological product, and performing an analysis of the first inspection data to generate second inspection data of the biological product, wherein the preset inspection standard is an inspection standard based on a biological metabonomics method.

2. The block chain system according to claim 1, wherein the determining first inspection data of a biological product comprises:
acquiring inspection reward information corresponding to the biological product sent by a first user;
generating and publishing contract information according to the inspection reward information;
determining m second users according to the contract information; and
acquiring m groups of inspection data of the biological product offered by the m second users as the first inspection data of the biological product.

3. The block chain system according to claim 2, wherein, after the determining m second users according to the contract information, the determining first inspection data of a biological product further comprises:
if n second users among the m second users break a contract, re-determining n new second users, wherein the n new second users and (m-n) second users without breach of the contract constitute new m second users; and
the acquiring m groups of inspection data of the biological product offered by the m second users as the first inspection data of the biological product comprises:
acquiring m groups of inspection data of the biological product offered by the new m second users as the first inspection data of the biological product.

4. The block chain system according to claim 2, wherein the performing an analysis of the first inspection data to generate second inspection data of the biological product comprises:
determining a median of the m groups of inspection data according to the m groups of inspection data; and
generating the second inspection data according to the median and the m groups of inspection data, wherein the second inspection data comprises inspection analysis data and product inspection result data of the m groups of inspection data.

5. The block chain system according to claim 1, wherein the processor further comprises a data application layer in communication with the product inspection layer, used for acquiring a product inspection code generated based on the second inspection data, a product circulation code generated based on product circulation information of the biological product and a product registration code generated based on product registration information of the biological product, and generating a transaction contract according to the product inspection code, the product circulation code and the product registration code.

6. The block chain system according to claim 5, wherein the processor further comprises a product circulation layer in communication with the data application layer, used for storing the product circulation information, generating the product circulation code according to the product circulation information and transmitting the product circulation code to the data application layer.

7. The block chain system according to claim 5, wherein the processor further comprises a product registration layer in communication with the data application layer, used for storing the product registration information, generating the product registration code according to the product registration information and transmitting the product registration code to the data application layer.

8. The block chain system according to claim 1, wherein the biological product comprises at least one of agricultural products, reprocessed agricultural products, traditional Chinese medicine products, reprocessed traditional Chinese medicine products, food and feed products.

9. The block chain system according to claim 1, wherein the product inspection layer is further used for generating a metabolome database according to the first inspection data.

10. The block chain system according to claim 1, wherein the first inspection data is original inspection data of an inspection sample of the biological product generated by an inspection agency.

11. The block chain system according to claim 1, wherein the second inspection data comprises a product identification code and a product inspection result presented in a form of product quality report data and/or product authenticity report data.

12. The block chain system according to claim 1, wherein the biological metabonomics method comprises at least one of metabolome fingerprint, metabolome global analysis, and targeted metabolite analysis.

13. The block chain system according to claim 1, wherein the first inspection data and the second inspection data are stored separately.

14. A biological product monitoring method applied to a block chain system comprising a product inspection layer wherein a preset inspection standard is stored, comprising:
acquiring first inspection data of a biological product by using the product inspection layer, wherein the first inspection data is generated based on the preset inspection standard, and the preset inspection standard is an inspection standard based on a biological metabonomics method; and
performing an analysis of the first inspection data to generate second inspection data of the biological product by using the product inspection layer.

15. The biological product monitoring method according to claim 14, wherein the block chain system further comprises a data application layer in communication with the product inspection layer, and after the performing an analysis of the first inspection data to generate second inspection data of the biological product by using the product inspection layer, the biological product monitoring method further comprises:
generating a product inspection code according to the second inspection data by using the product inspection layer; and
transmitting the product inspection code, a product circulation code generated based on product circulation information of the biological product, and a product registration code generated based on product registration information of the biological product to the data application layer to generate a transaction contract by using the data application layer.

16. The biological product monitoring method according to claim 15, wherein the block chain system further comprises a product circulation layer and/or a product registration layer in communication with the data application layer, and before the transmitting a product inspection code, a product circulation code generated based on product circulation information, and a product registration code generated based on product registration information to the data application layer to generate a transaction contract by using the data application layer, the biological product monitoring method further comprises:
storing the product circulation information and generating the product circulation code according to the product circulation information by using the product circulation layer; and/or
storing the product registration information and generating the product registration code according to the product registration information by using the product registration layer.

17. The biological product monitoring method according to claim 15, wherein, after the transmitting the product inspection code, a product circulation code generated based on product circulation information of the biological product, and a product registration code generated based on product registration information of the biological product to the data application layer to generate a transaction contract by using the data application layer, the biological product monitoring method further comprises at least one of following steps:
acquiring a transaction demand of a third user, and performing a transaction operation according to the transaction demand and the transaction contract;
acquiring a viewing demand of a fourth user, and performing a viewing operation according to the viewing demand; and
acquiring an application demand of a fifth user, and performing a data application operation according to the application demand.

18. The biological product monitoring method according to of claim 14, wherein, after the acquiring first inspection data of a biological product by using the product inspection layer, the biological product monitoring method further comprises:
generating a metabolome database according to the first inspection data by using the product inspection layer.

19. A non-transitory computer-readable storage medium wherein a computer program is stored for performing the biological product monitoring method according to claim 14.

20. An electronic device comprising:
a processor; and
a memory for storing executable instructions of the processor,
wherein the processor is used for implementing the biological product monitoring method according to claim 14.
